(19) United States
(12) Patent Application Publication
(10) Pub. No.: US 2020/0193449 A1
(43) Pub. Date: Jun. 18, 2020

(54) SYSTEM AND METHOD OF AUTHENTICATING CONFORMITY TO SPECIFICATION USING A DISTRIBUTED LEDGER

(71) Applicant: ABAXX TECHNOLOGIES INC., Toronto (CA)

(72) Inventors: JOSHUA CRUMB, CHRIST CHURCH (BB); ANDREW FEDAK, CHRIST CHURCH (BB); CHRISTOPHER A. WIKLOF, EVERETT, WA (US)

(21) Appl. No.: 16/684,522

(22) Filed: Nov. 14, 2019

Related U.S. Application Data
(60) Provisional application No. 62/767,697, filed on Nov. 15, 2018.

(51) Int. Cl. G06Q 30/00; G06F 16/27; G06Q 20/38

(52) U.S. Cl. CPC G06Q 30/018; G06Q 20/389; G06F 16/27

(57) ABSTRACT

A computer method and system provide for transferring an interest in a commodity with authenticated conformity to a specification using a distributed ledger.

### CROSS-REFERENCE TO RELATED APPLICATIONS

The present application claims priority benefit from co-pending U.S. Provisional Patent Application No. 62/767,697, entitled “SYSTEM AND METHOD OF AUTHENTICATING CONFORMITY TO SPECIFICATION USING A DISTRIBUTED LEDGER,” filed Nov. 15, 2018 (docket number 3058-004-02), which application, to the extent not inconsistent with the disclosure herein, is incorporated herein by reference.

### SUMMARY

According to an embodiment, a computer method for transferring an interest in a commodity with authenticated conformity to a specification includes receiving into a server computer, via respective graphical user interfaces (GUIs), agreements from a party and a counterparty to transfer an interest in a specified commodity. The server computer establishes a smart contract to transfer the interest in the commodity, the smart contract including a clause requiring conformance to the specification. The server computer records the smart contract and the respective agreements to terms of the smart contract by the party and the counterparty in a distributed ledger. When the server computer, via a network interface, receives commodity assay data proving the commodity conforms to the specification, the server computer records the commodity assay data in the distributed ledger and completes the transfer of the interest in the commodity responsive to the recordation of the commodity assay data.

According to an embodiment, a computer system configured to transfer an interest in a commodity with authenticated conformity to a specification includes a server computer that is operatively coupled to a plurality of end devices, each of the end devices having electronic displays capable of displaying respective GUIs. The server computer is configured to receive agreements from a party and a counterparty from respective end devices, and to establish a smart contract to transfer an interest in a specified commodity, the smart contract including a clause requiring conformance to the specification. The plurality of end devices have respective non-transitory computer readable media that collectively carry a distributed ledger. The server computer is configured to record, into the distributed ledger, the smart contract and the respective agreements to terms of the smart contract by the party and the counterparty. A web server is operatively coupled to the server computer. The web server includes a network interface. The web server is configured to receive and transmit to the server computer commodity assay data, from an assay source, that proves the commodity conforms to the specification. The server computer is configured to record the commodity assay data in the distributed ledger and to complete the transfer of the interest in the commodity responsive to the recorded commodity assay data.

### BRIEF DESCRIPTION OF THE DRAWINGS

FIG. 1 is a flow chart illustrating a computer method for transferring an interest in a commodity with authenticated conformity to a specification, according to an embodiment.

FIG. 2 is a flow chart illustrating a computer method for executing a transfer of interest in a commodity only after the commodity meets a specification, according to an embodiment.

FIG. 3 is a block diagram of a computer system configured to transfer an interest in a commodity with authenticated conformity to a specification, according to an embodiment.

FIG. 4 is a block diagram of an end device included in the computer system of FIG. 3, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

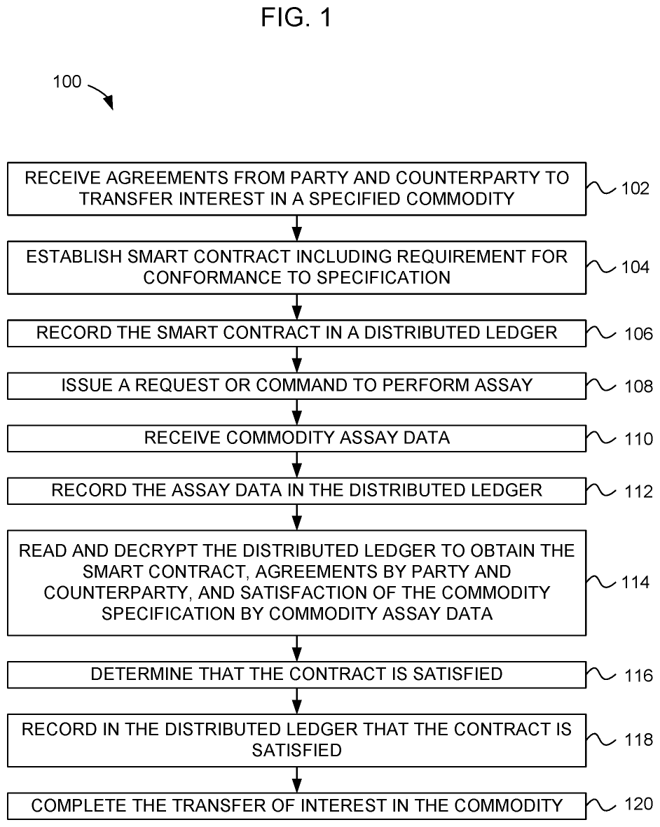

FIG. 1 is a flow chart illustrating a computer method 100 for transferring an interest in a commodity with authenticated conformity to a specification, according to an embodiment.

According to an embodiment, a computer method 100 for transferring an interest in a commodity with authenticated conformity to a specification includes, in step 102, receiving into a server computer, via respective graphical user interfaces (GUIs), agreements from a party and a counterparty to transfer an interest in a specified commodity. Step 104 includes establishing, with the server computer, a smart contract to transfer the interest in the commodity. The smart contract may include a clause requiring conformance to the specification. Step 106 includes recording, with the server computer, the smart contract and the respective agreements to terms of the smart contract by the party and the counterparty in a distributed ledger. Step 110 includes receiving, with the server computer via a network interface, commodity assay data that proves the commodity conforms to the specification. Step 112 includes recording, with the server computer, the commodity assay data in the distributed ledger. Step 120 includes completing the transfer of the interest in the commodity responsive to the recordation of the commodity assay data.

According to an embodiment, the computer method 100 further includes, in step 108, issuing a request or command for the commodity assay to be performed. In an embodiment, issuing the request or command for the commodity assay to be performed includes, in step 108, determining that a condition for performance of the commodity assay has been met, followed by transmitting request or command data from the server computer, via a web interface, to a recipient specified by the smart contract. For example, the specified recipient may include a web address for accessing data from automated equipment such as a webcam. In another example, the specified recipient may include an agreed-upon provider of commodity assay testing. In an embodiment, determining that the condition for performance of the commodity assay has been met may include accessing the smart contract in the distributed ledger, reading a specified date or date range in the smart contract, followed by reading a system date, and determining that the condition for performance of the commodity assay has been met when the system date equals the specified date or falls within the specified date range. In an embodiment, determining that the condition for performance of the commodity assay has been met may include accessing the smart contract in the distributed ledger, reading a specified action in the smart contract, and determining that the condition for performance of the commodity assay has been met when data indicating the specified action has occurred is received into the server computer via the web interface.

In an embodiment, the specified action may include production of the commodity from a wellhead. In another embodiment, the specified action may include conveyance of the commodity to a predetermined location. Additionally or alternatively, the specified action may include harvesting of the commodity, mining of the commodity, or refining of the commodity.

According to an embodiment, the computer method 100 further includes, in step 114, reading and decrypting, from the distributed ledger, with the server computer using a private key, the recorded smart contract, the agreements to terms of the smart contract, and the satisfaction of the specification with the commodity assay data. Step 116 includes determining that the smart contract is satisfied. Step 118 includes recording, with the server computer in the distributed ledger, that the smart contract is satisfied.

In an embodiment, completing the transfer of the interest in the commodity, in step 120, includes transferring funds between the party and the counterparty, recording the transfer of the funds in the distributed ledger, and transferring title to the specified commodity.

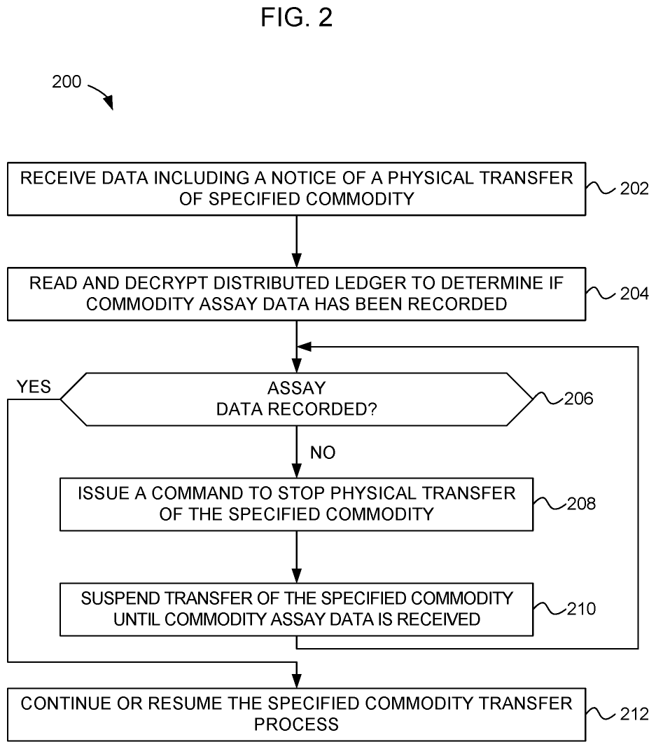

FIG. 2 is a flow chart illustrating a computer method 200 for executing a transfer of interest in a commodity only after the commodity meets a specification, according to an embodiment.

According to an embodiment, the computer method 200 further includes, in step 210, suspending, before receiving the commodity assay data, in step 110, a transfer process before the specification is proved. Step 212 includes resuming the transfer process after receiving the commodity assay data. In an embodiment, the transfer process includes a logical transfer of title to the specified commodity. In an embodiment, the transfer process includes a physical transfer of the specified commodity.

According to an embodiment, the computer method 200 further includes, in step 208, issuing a command to stop the physical transfer of the specified commodity.

According to an embodiment, the computer method 200 further includes, in step 202, receiving, via the network interface, data including a notice that the physical transfer of the specified commodity is scheduled or in process. Step 204 includes reading the distributed ledger to determine if the commodity assay data has been recorded. In an embodiment, step 204 includes decrypting the distributed ledger. In an embodiment, including an embodiment wherein a remote storage system such as Inter Planetary File System (IPFS) or FileCoin is used to store the commodity assay data, step 204 includes reading (and optionally decrypting) the distributed ledger to obtain a remote storage address, and reading the remote storage address to determine if the commodity assay data has been recorded. Step 208 includes issuing a command to stop the physical transfer of the commodity when the commodity assay data has not been recorded in step 206. In an embodiment, receiving data including the notice that the physical transfer of the specified commodity is scheduled or in process, in step 202, includes reading and decrypting the distributed ledger to determine a schedule transfer date.

In an embodiment, transferring the interest, in step 212, includes transferring ownership.

In an embodiment, the distributed ledger, in step 204, includes a blockchain. For example, the blockchain may include a public blockchain, a private blockchain, or a permissioned blockchain. In one embodiment, the blockchain includes an Etherium ERC20 blockchain.

Referring to FIG. 1, in an embodiment, recording the smart contract in the distributed ledger, in step 106, includes hashing the smart contract, storing the hashed smart contract at a secret location in a cloud asset, encrypting the secret location, and writing the encrypted secret location into the blockchain as a transaction. In an embodiment, recording the smart contract in the distributed ledger, in step 106, further includes encrypting a private key, holding the encrypted private key in trust, and transmitting public keys to the party and the counterparty.

Referring to FIG. 2, in an embodiment, suspending the transfer process, in step 210, includes suspending a transfer of funds. In an embodiment, resuming the transfer process, in step 212, includes resuming the transfer of funds.

In an embodiment, suspending the transfer process, in step 210, includes suspending authorization to process the commodity. In an embodiment, resuming the transfer process, in step 212, includes authorizing the transfer process of the commodity.

In an embodiment, the transfer process, in step 212, includes processing the commodity to obtain a physical or chemical change. In another embodiment, the transfer process, in step 212, includes obtaining the commodity from an in-ground deposit. Additionally or alternatively, the transfer process, in step 212, includes harvesting the commodity or physically transporting the commodity.

Referring back to FIG. 1, in an embodiment, receiving the commodity assay data, in step 110, includes receiving commodity assay data from a certified third party assay agent. In an embodiment, receiving the commodity assay data, in step 110, includes receiving quantity data for the specified commodity from an automated measurement apparatus having communication capability with the network interface.

In an embodiment, the smart contract includes a price that is a function of the commodity assay data. In an embodiment, completing the transfer of the interest in the commodity, in step 120, includes calculating the price as a function of the commodity assay data.

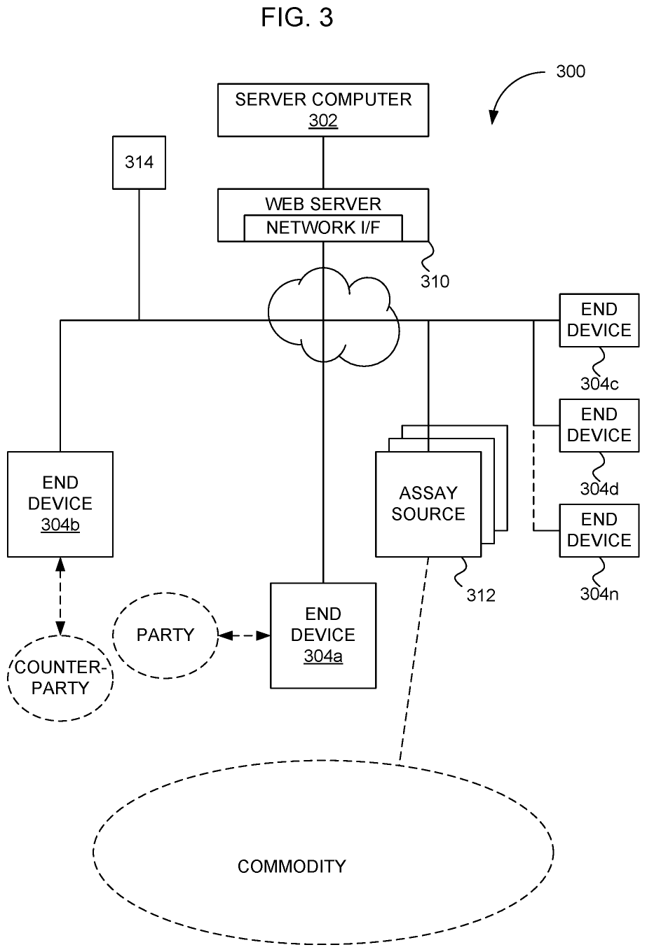

FIG. 3 is a block diagram of a computer system 300 configured to transfer an interest in a commodity with authenticated conformity to a specification, according to an embodiment.

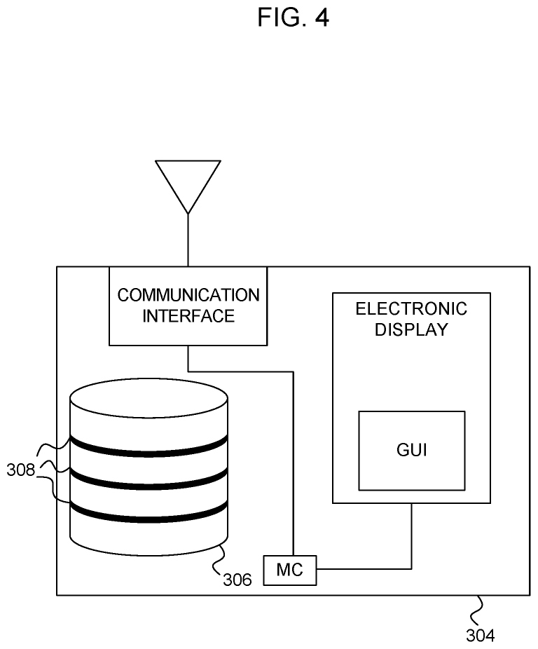

According to an embodiment, a computer system 300 configured to transfer an interest in a commodity with authenticated conformity to a specification includes a server computer 302 operatively coupled to a plurality of end devices 304a, 304b, 304c, 304d, . . . , 304n, each of the end devices 304a, 304b, 304c, 304d, . . . , 304n having electronic displays capable of displaying respective graphical user interfaces (GUIs). In an embodiment, the server computer 302 is configured to receive agreements from a party and a counterparty from respective end devices 304a, 304b, and to establish a smart contract to transfer an interest in a specified commodity. The smart contract may include a clause that requires conformance to the specification. Referring to FIG. 4, in an embodiment, the plurality of end devices 304a, 304b, 304c, 304d, . . . , 304n have respective non-transitory computer readable media, shown as 306 in FIG. 4, that collectively carry a distributed ledger 308. In an embodiment, the server computer 302 is configured to record, into the distributed ledger 308, the smart contract and the respective agreements to terms of the smart contract by the party and the counterparty. Referring again to FIG. 3 with reference to FIG. 4, in an embodiment, a web server 310 is operatively coupled to the server computer 302. The web server 310 may include a network interface. The web server 310 may be configured to receive and transmit to the server computer 302 commodity assay data, from an assay source 312, that proves the commodity conforms to the specification. In an embodiment, the server computer 302 is configured to record the commodity assay data in the distributed ledger 308 and to complete the transfer of the interest in the commodity responsive to the recorded commodity assay data.

In an embodiment, the server computer 302 is configured to establish a smart contract that includes a price that is a function of the commodity assay data. In an embodiment, the server computer 302 is configured to complete the transfer of the interest in the commodity by steps that include calculating the price as a function of the commodity assay data.

In an embodiment, receiving the commodity assay data, in step 110, may include receiving commodity assay data from an assay source 312. The assay source 312 may, for example, include a certified third party assay agent 312.

In an embodiment, the assay source 312 includes an automated or semi-automated measurement apparatus 312. Receiving the commodity assay data, in step 110, may include receiving quantity data for the specified commodity from an automated measurement apparatus 312 that has communication capability with the web server 310.

FIG. 4 is a block diagram of an end device 304 included in the computer system 300 of FIG. 3, according to an embodiment.

In an embodiment, the server computer 302 (not shown in FIG. 4) is further configured to issue a request or command for the commodity assay to be performed. In an embodiment, issuing the request or command, by the server computer 302, for the commodity assay to be performed includes determining that a condition for performance of the commodity assay has been met, followed by transmitting request or command data from the server computer 302, via the web server 310 (not shown in FIG. 4), to the assay source 312 (not shown in FIG. 4) specified by the smart contract. In an embodiment, determining that a condition for performance of the commodity assay has been met, by the server computer 302, includes accessing the smart contract on the distributed ledger 308, reading a specified date or date range in the smart contract, and determining that the condition for performance of the commodity assay has been met when a system date equals the specified date or falls within the date range. In an embodiment, determining that the condition for performance of the commodity assay has been met, by the server computer 302, includes accessing the smart contract on the distributed ledger 308, reading a specified action in the smart contract, and determining that the condition for performance of the commodity assay has been met when data indicating the specified action has occurred is received into the server computer 302 via a web interface. For example, the specified action may include production of the commodity from a wellhead, conveyance of the commodity to a predetermined location, harvesting of the commodity, mining of the commodity, and/or refining the commodity.

In an embodiment, the server computer 302 is further configured to read and decrypt, from the distributed ledger 308, the recorded smart contract, the agreements to terms of the smart contract, and the satisfaction of the specification with the commodity assay data, determine that the smart contract is satisfied, and record, in the distributed ledger 308, that the smart contract is satisfied.

In an embodiment, completing the transfer of the interest in the commodity, in step 120, by the server computer 302, includes transferring funds between the party and the counterparty, recording the transfer of funds in the distributed ledger 308, and transferring title to the specified commodity.

In an embodiment, the server computer 302 is further configured to transmit data to suspend, before receiving the commodity assay data, a transfer process before the specification is proved, and to transmit data to resume the transfer process after receiving the commodity assay data.

According to an embodiment, the transfer process includes a logical transfer of title to the specified commodity. In another embodiment, the transfer process includes a physical transfer of the specified commodity.

In an embodiment, the server computer 302 is configured to issue a command to stop the physical transfer of the commodity.

In an embodiment, the server computer 302 is configured to receive, via the web server 310, data that includes a notice that the physical transfer is scheduled or in process, to read and decrypt the distributed ledger 308 to determine if the commodity assay data has been recorded, and to issue the command to stop the physical transfer of the commodity when the commodity assay data has not been recorded.

In an embodiment, the distributed ledger 308 includes a blockchain.

In an embodiment, the distributed ledger 308 includes a public blockchain. In an embodiment, the distributed ledger 308 may include an Etherium ERC20 blockchain.

In an embodiment, the distributed ledger 308 includes a private blockchain.

In an embodiment, the distributed ledger 308 includes a permissioned blockchain.

In an embodiment, recording the smart contract in the distributed ledger 308, by the server computer 302, includes hashing the smart contract, storing the hashed smart contract at a secret location in a cloud asset 314 (see FIG. 3), encrypting the secret location, and writing the encrypted secret location into the distributed ledger 308 as a transaction. In an embodiment, recording the smart contract in the distributed ledger 308, by the server computer 302, further includes encrypting a private key, holding the encrypted private key in trust, and transmitting public keys to the party and the counterparty.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer method for transferring an interest in a commodity with authenticated conformity to a specification, comprising:
receiving into a server computer, via respective graphical user interfaces (GUIs), agreements from a party and a counterparty to transfer an interest in a specified commodity;
establishing, with the server computer, a smart contract to transfer the interest in the commodity, the smart contract including a clause requiring conformance to the specification;
recording, with the server computer, the smart contract and the respective agreements to terms of the smart contract by the party and the counterparty in a distributed ledger;
receiving, with the server computer via a network interface, commodity assay data proving the commodity conforms to the specification;
recording, with the server computer, the commodity assay data in the distributed ledger; and
completing the transfer of the interest in the commodity responsive to the recordation of the commodity assay data.

2. The computer method for transferring an interest in a commodity with authenticated conformity to a specification of claim 1, further comprising:
issuing a request or command for the commodity assay to be performed.

3. The computer method for transferring an interest in a commodity with authenticated conformity to a specification of claim 2, wherein issuing the request or command for the commodity assay to be performed comprises:
determining that a condition for performance of the commodity assay has been met; and
transmitting request or command data from the server computer, via a web interface, to a recipient specified by the smart contract.

4. The computer method for transferring an interest in a commodity with authenticated conformity to a specification of claim 3, wherein determining that the condition for performance of the commodity assay has been met comprises:
accessing the smart contract in the distributed ledger;
reading a specified date or date range in the smart contract;
reading a system date; and
determining that the condition for performance of the commodity assay has been met when the system date equals the specified date or falls within the specified date range.

5. The computer method for transferring an interest in a commodity with authenticated conformity to a specification of claim 3, wherein determining that the condition for performance of the commodity assay has been met comprises:
accessing the smart contract in the distributed ledger;
reading a specified action in the smart contract; and
determining that the condition for performance of the commodity assay has been met when data indicating the specified action has occurred is received into the server computer via the web interface.

6. The computer method for transferring an interest in a commodity with authenticated conformity to a specification of claim 5, wherein the specified action comprises production of the commodity from a wellhead.

7. The computer method for transferring an interest in a commodity with authenticated conformity to a specification of claim 5, wherein the specified action comprises conveyance of the commodity to a predetermined location.

8. The computer method for transferring an interest in a commodity with authenticated conformity to a specification of claim 5, wherein the specified action comprises harvesting of the commodity.

9. The computer method for transferring an interest in a commodity with authenticated conformity to a specification of claim 5, wherein the specified action comprises mining of the commodity.

10. The computer method for transferring an interest in a commodity with authenticated conformity to a specification of claim 5, wherein the specified action comprises refining of the commodity.

11. The computer method for transferring an interest in a commodity with authenticated conformity to a specification of claim 1, further comprising:
reading and decrypting, from the distributed ledger, with the server computer using a private key, the recorded smart contract, the agreements to terms of the smart contract, and the satisfaction of the specification with the commodity assay data;
determining that the smart contract is satisfied; and
recording, with the server computer in the distributed ledger, that the smart contract is satisfied.

12. The computer method for transferring an interest in a commodity with authenticated conformity to a specification of claim 1, wherein completing the transfer of the interest in the commodity comprises:
transferring funds between the party and the counterparty;
recording the transfer of the funds in the distributed ledger; and
transferring title to the specified commodity.

13. The computer method for transferring an interest in a commodity with authenticated conformity to a specification of claim 1, further comprising:
suspending, before receiving the commodity assay data, a transfer process before the specification is proved; and
resuming the transfer process after receiving the commodity assay data.

14. The computer method for transferring an interest in a commodity with authenticated conformity to a specification of claim 13, wherein the transfer process comprises a logical transfer of title to the specified commodity.

15. The computer method for transferring an interest in a commodity with authenticated conformity to a specification of claim 13, wherein the transfer process comprises a physical transfer of the specified commodity.

16. The computer method for transferring an interest in a commodity with authenticated conformity to a specification of claim 13, further comprising:
issuing a command to stop the physical transfer of the commodity.

17. The computer method for transferring an interest in a commodity with authenticated conformity to a specification of claim 13, further comprising:
receiving, via the network interface, data including a notice that the physical transfer of the specified commodity is scheduled or in process;
reading the distributed ledger to determine if the commodity assay data has been recorded; and
issuing a command to stop the physical transfer of the commodity when the commodity assay data has not been recorded.

18. The computer method for transferring an interest in a commodity with authenticated conformity to a specification of claim 17, wherein receiving data including the notice that the physical transfer of the specified commodity is scheduled or in process comprises reading and decrypting the distributed ledger to determine a scheduled transfer date.

19. The computer method for transferring an interest in a commodity with authenticated conformity to a specification of claim 1, wherein transferring the interest comprises transferring ownership.

20. The computer method for transferring an interest in a commodity with authenticated conformity to a specification of claim 1, wherein the distributed ledger comprises a blockchain.

21. The computer method for transferring an interest in a commodity with authenticated conformity to a specification of claim 1, wherein recording the smart contract in the distributed ledger comprises:
hashing the smart contract;
storing the hashed smart contract at a secret location in a cloud asset;
encrypting the secret location; and
writing the encrypted secret location into the blockchain as a transaction.

22. The computer method for transferring an interest in a commodity with authenticated conformity to a specification of claim 21, wherein recording the smart contract in the distributed ledger further comprises:
encrypting a private key;
holding the encrypted private key in trust; and
transmitting public keys to the party and the counterparty.

23. The computer method for transferring an interest in a commodity with authenticated conformity to a specification of claim 13, wherein suspending the transfer process comprises suspending a transfer of funds; and
wherein resuming the transfer process comprises resuming the transfer of funds.

24. The computer method for transferring an interest in a commodity with authenticated conformity to a specification of claim 13, wherein suspending the transfer process comprises suspending authorization to process the commodity; and
wherein resuming the transfer process comprises authorizing the transfer process of the commodity.

25. The computer method for transferring an interest in a commodity with authenticated conformity to a specification of claim 24, wherein the transfer process comprises processing the commodity to obtain a physical or chemical change.

26. The computer method for transferring an interest in a commodity with authenticated conformity to a specification of claim 24, wherein the transfer process comprises obtaining the commodity from an in-ground deposit.

27. The computer method for transferring an interest in a commodity with authenticated conformity to a specification of claim 24, wherein the transfer process comprises harvesting the commodity.

28. The computer method for transferring an interest in a commodity with authenticated conformity to a specification of claim 24, wherein the transfer process comprises physically transporting the commodity.

29. The computer method for transferring an interest in a commodity with authenticated conformity to a specification of claim 1, wherein receiving the commodity assay data comprises receiving commodity assay data from a certified third party assay agent.

30. The computer method for transferring an interest in a commodity with authenticated conformity to a specification of claim 1, wherein receiving the commodity assay data comprises receiving quantity data for the specified commodity from an automated measurement apparatus having communication capability with the network interface.

31. The computer method for transferring an interest in a commodity with authenticated conformity to a specification of claim 1, wherein the smart contract includes a price that is a function of the commodity assay data; and
wherein completing the transfer of the interest in the commodity includes calculating the price as a function of the commodity assay data.

32. A computer system configured to transfer an interest in a commodity with authenticated conformity to a specification, comprising:
a server computer operatively coupled to a plurality of end devices, each of the end devices having electronic displays capable of displaying respective graphical user interfaces (GUIs), wherein the server computer is configured to receive agreements from a party and a counterparty from respective end devices, and to establish a smart contract to transfer an interest in a specified commodity, the smart contract including a clause requiring conformance to the specification;
the plurality of end devices having respective non-transitory computer readable media collectively carrying a distributed ledger, wherein the server computer is configured to record, into the distributed ledger, the smart contract and the respective agreements to terms of the smart contract by the party and the counterparty; and
a web server operatively coupled to the server computer, the web server including a network interface, the web server being configured to receive and transmit to the server computer commodity assay data, from an assay source, proving the commodity conforms to the specification;
wherein the server computer is configured to record the commodity assay data in the distributed ledger and to complete the transfer of the interest in the commodity responsive to the recorded commodity assay data.

33. The computer system configured to transfer an interest in a commodity with authenticated conformity to a specification of claim 32, wherein the server computer is configured to establish a smart contract that includes a price that is a function of the commodity assay data; and
wherein the server computer is configured to complete the transfer of the interest in the commodity by steps including calculating the price as a function of the commodity assay data.

34. The computer system configured to transfer an interest in a commodity with authenticated conformity to a specification of claim 32, wherein receiving the commodity assay data comprises receiving commodity assay data from a certified third party assay agent.

35. The computer system configured to transfer an interest in a commodity with authenticated conformity to a specification of claim 32, wherein receiving the commodity assay data comprises receiving quantity data for the specified commodity from an automated measurement apparatus having communication capability with the web server.

36. The computer system configured to transfer an interest in a commodity with authenticated conformity to a specification of claim 32, wherein the server computer is further configured to issue a request or command for the commodity assay to be performed.

37. The computer system configured to transfer an interest in a commodity with authenticated conformity to a specification of claim 36, wherein issuing the request or command, by the server computer, for the commodity assay to be performed comprises:
determining that a condition for performance of the commodity assay has been met; and
transmitting request or command data from the server computer, via the web server, to the assay source specified by the smart contract.

38. The computer system configured to transfer an interest in a commodity with authenticated conformity to a specification of claim 37, wherein determining that the condition for performance of the commodity assay has been met, by the server computer, comprises:
accessing the smart contract on the distributed ledger;
reading a specified date or date range in the smart contract; and
determining that the condition for performance of the commodity assay has been met when a system date equals the specified date or falls within the specified date range.

39. The computer system configured to transfer an interest in a commodity with authenticated conformity to a specification of claim 37, wherein determining that the condition for performance of the commodity assay has been met, by the server computer, comprises:
accessing the smart contract on the distributed ledger;
reading a specified action in the smart contract; and
determining that the condition for performance of the commodity assay has been met when data indicating the specified action has occurred is received into the server computer via the web server.

40. The computer system configured to transfer an interest in a commodity with authenticated conformity to a specification of claim 32, wherein the server computer is further configured to read and decrypt, from the distributed ledger, the recorded smart contract, the agreements to terms of the smart contract, and the satisfaction of the specification with the commodity assay data;
determine that the smart contract is satisfied; and
record, in the distributed ledger, that the smart contract is satisfied.

41. The computer system configured to transfer an interest in a commodity with authenticated conformity to a specification of claim 32, wherein completing the transfer of the interest in the commodity by the server computer comprises:
transferring funds between the party and the counterparty;
recording the transfer of the funds in the distributed ledger; and
transferring title to the specified commodity.

42. The computer system configured to transfer an interest in a commodity with authenticated conformity to a specification of claim 32, wherein the server computer is further configured to transmit data to suspend, before receiving the commodity assay data, a transfer process before the specification is proved; and
to transmit data to resume the transfer process after receiving the commodity assay data.

43. The computer system configured to transfer an interest in a commodity with authenticated conformity to a specification of claim 42, wherein the server computer is configured to issue a command to stop the physical transfer of the commodity.

44. The computer system configured to transfer an interest in a commodity with authenticated conformity to a specification of claim 42, wherein the server computer is configured to receive, via the web server, data including a notice that the physical transfer is scheduled or in process;
to read and decrypt the distributed ledger to determine if the commodity assay data has been recorded; and
to issue the command to stop the physical transfer of the commodity when the commodity assay data has not been recorded.

45. The computer system configured to transfer an interest in a commodity with authenticated conformity to a specification of claim 42, wherein suspending the transfer process comprises suspending a transfer of funds; and
wherein resuming the transfer process comprises resuming the transfer of funds.

46. The computer system configured to transfer an interest in a commodity with authenticated conformity to a specification of claim 42, wherein suspending the transfer process comprises suspending authorization to process the commodity; and
wherein resuming the transfer process comprises authorizing the transfer process of the commodity.

47. The computer system configured to transfer an interest in a commodity with authenticated conformity to a specification of claim 46, wherein the transfer process comprises processing the commodity to obtain a physical or chemical change.

48. The computer system configured to transfer an interest in a commodity with authenticated conformity to a specification of claim 46, wherein the transfer process comprises obtaining the commodity from an in-ground deposit.

49. The computer system configured to transfer an interest in a commodity with authenticated conformity to a specification of claim 46, wherein the transfer process comprises harvesting the commodity.

50. The computer system configured to transfer an interest in a commodity with authenticated conformity to a specification of claim 46, wherein the transfer process comprises physically transporting the commodity.

51. The computer system configured to transfer an interest in a commodity with authenticated conformity to a specification of claim 32, wherein transferring the interest comprises transferring ownership.

52. The computer system configured to transfer an interest in a commodity with authenticated conformity to a specification of claim 32, wherein the distributed ledger comprises a blockchain.

53. The computer system configured to transfer an interest in a commodity with authenticated conformity to a specification of claim 32, wherein the distributed ledger comprises a public blockchain.

54. The computer system configured to transfer an interest in a commodity with authenticated conformity to a specification of claim 53, wherein the distributed ledger comprises an Etherium ERC20 blockchain.

55. The computer system configured to transfer an interest in a commodity with authenticated conformity to a specification of claim 32, wherein the distributed ledger comprises a private blockchain.

56. The computer system configured to transfer an interest in a commodity with authenticated conformity to a specification of claim 32, wherein the distributed ledger comprises a permissioned blockchain.

57. The computer system configured to transfer an interest in a commodity with authenticated conformity to a specification of claim 32, wherein recording the smart contract in the distributed ledger, by the server computer, comprises:
hashing the smart contract;
storing the hashed smart contract at a secret location in a cloud asset;
encrypting the secret location; and
writing the encrypted secret location into the distributed ledger as a transaction.

58. The computer system configured to transfer an interest in a commodity with authenticated conformity to a specification of claim 57, wherein recording the smart contract in the distributed ledger, by the server computer, further comprises:
encrypting a private key;
holding the encrypted private key in trust; and
transmitting public keys to the party and the counterparty.
